(19) United States
(12) Patent Application Publication
(10) Pub. No.: US 2026/0323337 A1
(43) Pub. Date: Oct. 15, 2026

(54) MEASUREMENT REQUIREMENT FOR ENERGY SAVING

(71) Applicant: Nokia Technologies Oy, Espoo (FI)

(72) Inventors: Lei DU, Beijing (CN); Naizheng ZHENG, Beijing (CN)

(21) Appl. No.: 19/100,376

(22) PCT Filed: Aug. 8, 2022
(86) PCT No.: PCT/CN2022/110902

§ 371 Date: Jan. 31, 2025

(51) Int. Cl. H04W 24/10; H04W 24/08; H04W 76/28

(52) U.S. Cl. CPC H04W 24/10; H04W 24/08; H04W 76/28

(57) ABSTRACT

Embodiments of the present disclosure relate to devices, methods, apparatuses and computer readable storage media of the measurement requirement for the energy saving. The method comprises in accordance with a determination that a DTX is enabled by a second device, determining a relaxed measurement period associated with a measurement performed by the first device; and performing the measurement based on the relaxed measurement period or an unrelaxed measurement period. In this way, by introducing the relaxed measurement period, the required measurement accuracy may be achieved at the terminal device even the energy saving is enabled at the network device.

### FIELD

Embodiments of the present disclosure generally relate to the field of telecommunication and in particular to devices, methods, apparatuses and computer readable storage media of the measurement requirement for the energy saving.

### BACKGROUND

Energy consumption in 5th Generation Mobile Communication Technology (5G) new radio (NR) has been studied in the past few years, especially for the Radio Access Network (RAN), which may consume quite large part of the total energy consumption in the 5G network.

### SUMMARY

In general, example embodiments of the present disclosure provide a solution of coordinating the selection of the measurement requirement for the energy saving.

In a first aspect, there is provided a first device. The first device includes at least one processor; and at least one memory storing instructions that, when executed by the at least one processor, cause the first device at least to in accordance with a determination that a discontinuous transmission (DTX) is enabled by a second device, determine a relaxed measurement period associated with a measurement performed by the first device; and perform the measurement based on the relaxed measurement period or an unrelaxed measurement period.

In a second aspect, there is provided a second device. The second device includes at least one processor; and at least one memory storing instructions that, when executed by the at least one processor, cause the second device at least to configure a scaling factor for relaxing a measurement period associated with a measurement performed by a first device; and transmit the scaling factor to the first device.

In a third aspect, there is provide a method. The method comprises in accordance with a determination that a DTX is enabled by a second device, determining a relaxed measurement period associated with a measurement performed by the first device; and performing the measurement based on the relaxed measurement period or an unrelaxed measurement period.

In a fourth aspect, there is provide a method. The method comprises configuring a scaling factor for relaxing a measurement period associated with a measurement performed by a first device; and transmitting the scaling factor to the first device.

In a fifth aspect, there is provided an apparatus comprising means for, in accordance with a determination that a DTX is enabled by a second device, determining a relaxed measurement period associated with a measurement performed by the first device; and means for performing the measurement based on the relaxed measurement period or an unrelaxed measurement period.

In a sixth aspect, there is provided an apparatus comprising means for configuring a scaling factor for relaxing a measurement period associated with a measurement performed by a first device; and means for transmitting the scaling factor to the first device.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of the measurement requirement for the energy saving according to some example embodiments of the present disclosure;

FIG. 3 shows an example for scaling factor determination according to some example embodiments of the present disclosure;

FIG. 4 shows a flowchart of an example method of the measurement requirement for the energy saving according to some example embodiments of the present disclosure;

FIG. 5 shows a flowchart of an example method of the measurement requirement for the energy saving according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

### Example Environment

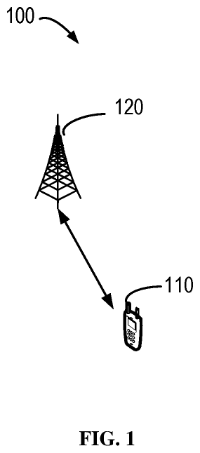

FIG. 1 shows an example communication network 100 in which embodiments of the present disclosure may be implemented. As shown in FIG. 1, the communication network 100 may include a terminal device 110. Hereinafter the terminal device 110 may also be referred to as a UE 110 or a first device 110.

The communication network 100 may further include a network device 120. Hereinafter the network device 120 may also be referred to as a gNB 120 or a second device 120. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

One of the key points in 5G NR may focus on energy consumption, especially for the RAN, which may consume quite large part of the total energy consumption in the 5G network. For example, the solutions for network energy savings in 5G has been studied. The study may aim at identifying network energy saving techniques in time, frequency, spatial, and power domains targeting both transmissions and receptions, and the support/feedback from UE and UE assistance information is also in scope of the study.

The DTX of the network side is a candidate solution that could provide network energy saving by turning on/off the network radio units, i.e., a power amplifier (PA), when there is no network transmission. With the improving of network hardware and software capability, the network DTX, e.g., with the hardware switching on/off the PA, can be performed in OFDM symbol level, which may be called as micro-DTX (μDTX).

The always-on transmission may be minimized in the 5G NR. Therefore, there are no common reference signal (CRS)-like reference signals in 5G NR. Instead, the only “always-on” NR signals is the so-called Synchronization Signal (SS) block, which is transmitted in a limited bandwidth and with a much larger periodicity compared to the LTE CRS. The SS block may be used for power measurements to estimate, for example, path loss and average channel quality. Furthermore, the Channel State Information-Reference Signal (CSI-RS) is reused in NR and extended to, for example, provide support for beam management and mobility as a complement to the SS block.

The SS block resource in NR is transmitted periodically with a period that may vary from 5 ms up to 160 ms. However, devices, which performs initial cell search or a cell search in inactive/idle state for mobility, may assume that the SS block is repeated at least once every 20 ms. This allows for a device that searches for an SS block in the frequency domain to know how long it must stay on each frequency before concluding that there is no Primary Synchronisation Signal (PSS)/Secondary Synchronisation Signal (SSS) present and that it should move on to the next frequency within the synchronization raster.

Moreover, the CSI-RS resource in NR may be configured with either periodic, semi-persistent, or aperiodic transmission in time. In the case of periodic CSI-RS transmission, the CSI-RS may be configured to be transmitted in every m-th slot, where the value m can be range from 4 to 640 slots. In the frequency domain, the CSI-RS may be configured within a given DL Bandwidth Part (BWP), where it may be configured to cover either the full bandwidth part or partial of the bandwidth part.

When the DTX or pDTX is applied by the network, the network may even decide to “mute” or lower the transmission power of some reference signals (RS)s, which may impact on UE measurement due to the absence or lower transmission power of the reference signals on which the UE measurement is to be performed.

Therefore, in a case where the network energy saving is enabled, the UE measurement behaviour may be further discussed, especially when the DTX or pDTX is applied by the network.

### Work Principle and Example Signaling for Communication

According to some example embodiments of the present disclosure, there is provided a solution for the measurement requirement for the energy saving. In this solution, the terminal device determines a relaxed measurement period in a case where the DTX is enabled at the network device. The terminal device may then determine which measurement period is to be used for the measurement performed by the terminal device, namely the relaxed measurement period or the unrelaxed measurement period. The terminal device performs the measurement based on the determined measurement period.

In this way, by introducing the relaxed measurement period, the required measurement accuracy may be achieved at the terminal device even the energy saving is enabled at the network device.

Example embodiments of the present disclosure will be described in detail below with reference to the accompanying drawings.

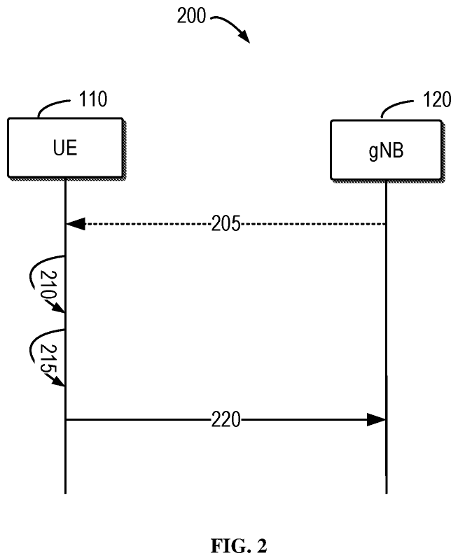

Reference is now made to FIG. 2, which shows a signaling chart 200 for communication according to some example embodiments of the present disclosure. As shown in FIG. 2, the signaling chart 200 involves a UE 110 and a gNB 120. For the purpose of discussion, reference is made to FIG. 1 to describe the signaling chart 200. Although a single UE 110 is illustrated in FIG. 2, it would be appreciated that there may be a plurality of UEs performing similar operations as described with respect to the UE 110 below.

As shown in FIG. 2, in a case where the UE 110 is aware of the energy saving of the gNB 120, for example, if the gNB 120 indicates 205 to the UE 110 that the DTX is enabled by the gNB 120, the UE 110 determines 210 a relaxed measurement period for one or more measurements to be performed by the UE 110. The measurement mentioned here may refer to different measurements included in the Layer 1 measurement(s), radio link failure (RLF)/beam failure detection (BFD) measurements and/or Layer 3 measurement(s), for example, a beam measurement, a radio resource measurement, a channel quality measurement etc.

For example, the UE 110 may determine a scaling factor for extending the unrelaxed measurement period, i.e., a measurement period used by the UE 110 when the energy saving is disabled at the gNB 120.

For example, the scaling factor may be determined by the UE 110 by considering an overlapping ratio between the μDTX period, measurement gaps, and the reference signals for the one or more measurements to be performed by the UE 110.

The term “μDTX period” or “DTX period” may refer to a period within which the gNB 120 may mute some reference signals or reduce the transmission power of reference signals. That is, within the μDTX period or DTX period, some reference signal to be used by the UE 110 may be absent. The DTX period may occur in periodic, semi-persistent or dynamic manner based on network decision. In case of periodic DTX operation, the network will mute or lower the transmission power of some RSs every DTX period hence the DTX period may be a fixed value. Furthermore, the measurement gap may refer to a time period within which the UE 110 may not perform any transmission or reception associated with the serving cell of the UE 110. Within the measurement gaps, the UE 110 may perform a measurement for an intra-frequency or inter-frequency neighbouring cell. Therefore, both μDTX or DTX period and the measurement gaps of the UE 110 may be considered to determine the scaling factor.

As another option, the UE 110 may determine the scaling factor based on the overlapping ratio between the μDTX period and SSB and/or CSI-RS symbols for the one or more measurements by the UE. In other words, the overlapping radio refers to the percentage that SSB and/or CSI-RS symbols to be measured are muted due to DTX operation. That is, the UE 110 may consider whether the reception of the SSB and/or CSI-RS symbols to be measured by the UE has been impacted when the DTX is enabled. For example, if the transmission occasion of the SSB and/or CSI-RS symbols from the gNB 120 is overlapped with the DTX period or the μDTX period, the SSB and/or CSI-RS symbols may not be received by the UE 110, which may impact on the measurement accuracy.

It is also possible that the scaling factor may also be determined by the UE 110 by considering the overlapping ratio between μDTX period and SSB measurement timing configuration (SMTC) windows/CSI-RS periodicity.

For example, assuming that a periodic or a semi-persistent DTX is enabled, when SMTC is partially overlapping with DTX period and the measurement gap is not configured, the scaling factor can be defined as K=1/(1−SMTC period/DTX period), if DTX period>SMTC period. If the measurement gap is configured, the scaling factor may be adjusted as K=1/(1−SMTC period/min (DTX period, MG periodicity).

Furthermore, it is also possible that there is no fixed DTX period, i.e., a dynamic DTX is enabled, the scaling factor may be estimated based on the overlapping ratio of SMTC windows or SSB/CSI-RS symbols to be measured with μDTX period, i.e., the percentage or ratio of SMTC windows overlapping with DTX within a time period e.g., measurement period.

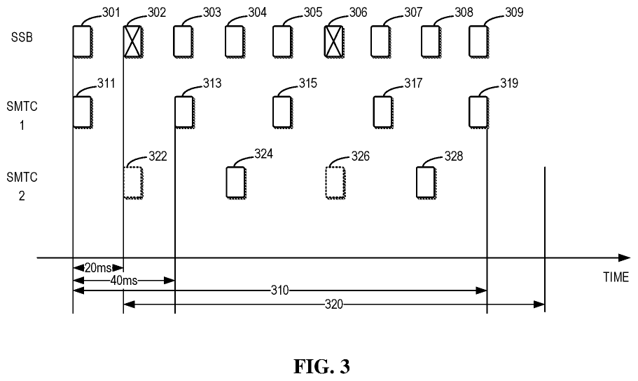

The example for determining the scaling factor may be further described with reference to FIG. 3. As shown, the SSB may be transmitted from the gNB 120 every 20 ms. If the DTX is enabled, the gNB 120 may omit the transmissions of the SSBs 302 and 306. The UE is configured with SMTC 1 where the SSB is to be measured by the UE. The SMTC 1 periodicity is 40 ms. For the UE side, with the SMTC 1, the SSB may be monitored/received by the UE 110 every 40 ms. After receiving the SSB 301 within the SMTC window 311, the UE 110 may receive the subsequent SSB 303 in next 40 ms SMTC window 313 and therefore the omitted SSB is the one the UE does not need to receive. In this example, although some RSs are overlapping with DTX period, these RSs are not to be measured by the UE hence this would not impact the UE measurement. With a measurement period 310, enough (e.g. five) SSB samples may be obtained by the UE 110 and a required measurement accuracy may not be impacted. Thus, the scaling factor may be set to K=1 and measurement period is not impacted by DTX.

Furthermore, the UE may be configured with the SMTC 2, the SSB may also be monitored/received by the UE 110 every 40 ms. However, the UE 110 may receive only one SSB 304 within the SMTC window 324 because the transmissions of the SSBs 302 and 306 are omitted or muted due to DTX operation. That is, the DTX period is overlapped with some of the SMTC period. In this case, the scaling factor may be set to K=1/(1-20/40) and measurement period is doubled.

Moreover, the scaling factor may also be configured by the gNB 120. In this case, the gNB 120 may transmit. for example, via the action 205, the scaling factor to the UE 110, for example, via a Radio Resource Control signalling. With the indicated scaling factor, the gNB 120 may be able to ensure a certain number of RSs being transmitted for UE measurement. In this option, where to mute the RSs is up to network implementation, which provides flexibility on network behaviour at the cost of degraded but controllable measurement performance.

Before the measurement is to be performed at the UE 110, the UE 110 may determine 215 which measurement period is used for the measurement. Within the measurement period, the UE 110 need to provide a measurement result satisfying the accuracy requirement.

As an option, the UE 110 may perform the measurement based on a relaxed measurement period when the DTX is enabled.

As another option, the UE 110 may use the relaxed measurement period only if when at least one channel quality criterion is met. For instance, when DTX is enabled, if the UE 110 determines that the channel quality is lower or no higher than a threshold level, the UE 110 may determine that the relaxed measurement period is to be used. The UE may miss some of the RSs if the SMTC is overlapping with DTX operation. However, the UE may still apply the unrelaxed measurement period if the channel quality or the latest measurement results, e.g., SS-RSRP, is above the threshold level. Since the channel is good enough, the performance of UE measurement may not be impacted, and the UE may still measure using a smaller number of samples to achieve the same measurement accuracy.

Alternatively, if the UE 110 determines that a channel quality variation is within a threshold within a predetermined time period, the UE 110 may still use the unrelaxed measurement period. By contrast, if the channel quality variation exceeds the threshold range within the predetermined time period, the UE 110 may determine that the relaxed measurement period is to be used.

Furthermore, the UE 110 may indicate 220, to the gNB 120, on whether the measurement result is derived based on an unrelaxed measurement period or a relaxed measurement period, so that the network can be aware of the performance of received measurement results. For example, the UE 110 may indicate which measurement period is used in the measurement report. It is to be understood that this indication may be transmitted to the gNB 120 via another suitable message.

According to the relaxed measurement period propose in the present disclosure, the relaxed requirement may be defined as below when DTX is enabled. The scaling factor may be applied to relax the PSS/SSS detection (as exampled below), the time period for time index detection and measurement period.

TABLE 1
Time period for PSS/SSS detection for Frequency range 1 (FR1)

| DRX cycle | T_{PSS/SSS}_{_{—}}_{sync}_{_{—}}ᵢₙₜᵣₐ |
|---|---|
| No DRX | max(600 ms, ceil(5 × K × Kₚ) × SMTC |
| | period)^{Note 1} × CSSFᵢₙₜᵣₐ |
| DRX cycle ≤ 320 ms | max(600 ms, ceil(M2 ^{Note 2} × 5 × K × Kₚ) × |
| | max(SMTC period, DRX cycle)) × CSSFᵢₙₜᵣₐ |
| DRX cycle > 320 ms | ceil(5 × K × Kₚ) × DRX cycle × CSSFᵢₙₜᵣₐ |

^{Note 1}
If different SMTC periodicities are configured for different cells, the SMTC period in the requirement is the one used by the cell being identified
^{Note 2}
When highSpeedMeasFlag-r16 is not configured, M2 = 1.5; When highSpeedMeasFlag-r16 is configured, M2 = 1.5 if SMTC periodicity >40 ms, otherwise M2 = 1.
NOTE 3:
When highSpeedMeasFlag-r16 is configured, the requirements apply only to UE supporting either measurementEnhancement-r16 or intraNR-MeasurementEnhancement-r16 on measurements of the primary component carrier and do not apply to measurements of a secondary component carrier with active SCell.

As one option, a separate scaling factor K can be added to relax the measurement period due to DTX operation as in Table 1.

TABLE 2
Time period for PSS/SSS detection for Frequency range 1 (FR1)

| DRX cycle | T_{PSS/SSS}_{_{—}}_{syne}_{_{—}}ᵢₙₜᵣₐ |
|---|---|
| No DRX | max(600 ms, ceil(5 × Kₚ′) × SMTC |
| | period)^{Note 1} × CSSFᵢₙₜᵣₐ |
| DRX cycle ≤ 320 ms | max(600 ms, ceil(M2 ^{Note 2} × 5 × Kₚ′) × |
| | max(SMTC period, DRX cycle)) × CSSFᵢₙₜᵣₐ |
| DRX cycle > 320 ms | ceil(5 × Kₚ′) × DRX cycle × CSSFᵢₙₜᵣₐ |

^{NOTE 1}
If different SMTC periodicities are configured for different cells, the SMTC period in the requirement is the one used by the cell being identified
^{NOTE 2}
When highSpeedMeasFlag-r16 is not configured, M2 = 1.5; When highSpeedMeasFlag-r16 is configured, M2 = 1.5 if SMTC periodicity >40 ms, otherwise M2 = 1.
NOTE 3:
When highSpeedMeasFlag-r16 is configured, the requirements apply only to UE supporting either measurementEnhancement-r16 or intraNR-MeasurementEnhancement-r16 on measurements of the primary component carrier and do not apply to measurements of a secondary component carrier with active SCell.

In Table 1, when intra-frequency SMTC is fully non-overlapping with DTX period, K=1. When intra-frequency SMTC is partially overlapping with measurement gaps, K=1/(1−(SMTC period/DTX period)), where SMTC period<DTX period.

Alternatively, a combined scaling factor Kp′ can be added to reflect the impact from both μDTX and measurement gaps as in Table 2. For example, when intra-frequency SMTC is fully non-overlapping with DTX period or measurement gap, Kp′=1. When intra-frequency SMTC is partially overlapping with DTX period or measurement gaps, Kp′=1/(1−(SMTC period/min (MRGP, DTX period)), where SMTC period<min (MRGP, DTX period).

With the solution of the present disclosure, required measurement accuracy may be achieved at the terminal device even the energy saving is enabled at the network device.

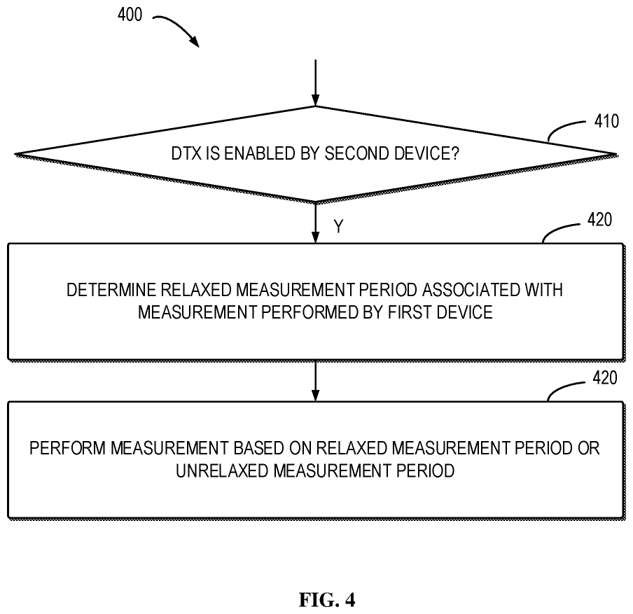

FIG. 4 shows a flowchart of an example method 400 of the measurement requirement for the network energy saving according to some example embodiments of the present disclosure. The method 400 may be implemented at the first device 110 as shown in FIG. 1. For the purpose of discussion, the method 400 will be described with reference to FIG. 1.

At 410, if the first device 110 determines a DTX is enabled by a second device at 410, and at 420 the first device 110 determines a relaxed measurement period associated with a measurement performed by the first device.

In some example embodiments, the first device may determine a DTX is enabled by a second device based on network indication, for instance, the enabling DTX and/or DTX period. This may be included in 205 in FIG. 2.

In some example embodiments, the first device may determine the relaxed measurement period based on a scaling factor, which is determined by the first device considering an overlapping ratio between the DTX period and at least one of a measurement gap for the measurement, one or more SSB or CSI-RS symbols to be measured, or a SMTC period or a CSI-RS periodicity.

In some example embodiments, the first device may determine whether the measurement gap is configured. If the measurement gap is configured, the first device may determine the scaling factor based on a ratio of the SMTC period to a minimum value between the DTX period and the measurement gap periodicity.

In some example embodiments, if the measurement gap is not configured, the first device may determine the scaling factor based on a ratio of the SMTC period to the DTX period.

In some example embodiments, if the DTX is not configured with a fix period, the first device may determine the overlapping ratio by monitoring the one or more symbols of SSB or CSI-RS within a predetermined period being muted after the DTX is enabled or the SMTC windows within the predetermined period being muted after the DTX is enabled.

In some example embodiments, the first device may determine the relaxed measurement period based on a scaling factor configured by the second device.

At 430, the first device 110 performs the measurement based on the relaxed measurement period or an unrelaxed measurement period.

In some example embodiments, if the at least one channel quality criterion is not fulfilled, the first device may determine that the relaxed measurement period is to be used for the measurement.

In some example embodiments, if the at least one channel quality criterion is fulfilled, the first device may determine that the unrelaxed measurement period is to be used for the measurement.

In some example embodiments, the at least one channel quality criterion comprises at least one of a channel quality is above a threshold level or a channel quality variation is within a threshold range within a predetermined time period.

In some example embodiments, the first device may transmit, to the second device, an indication that the relaxed measurement period is used for the measurement.

In some example embodiments, the first device comprises a terminal device and the second device comprises a network device.

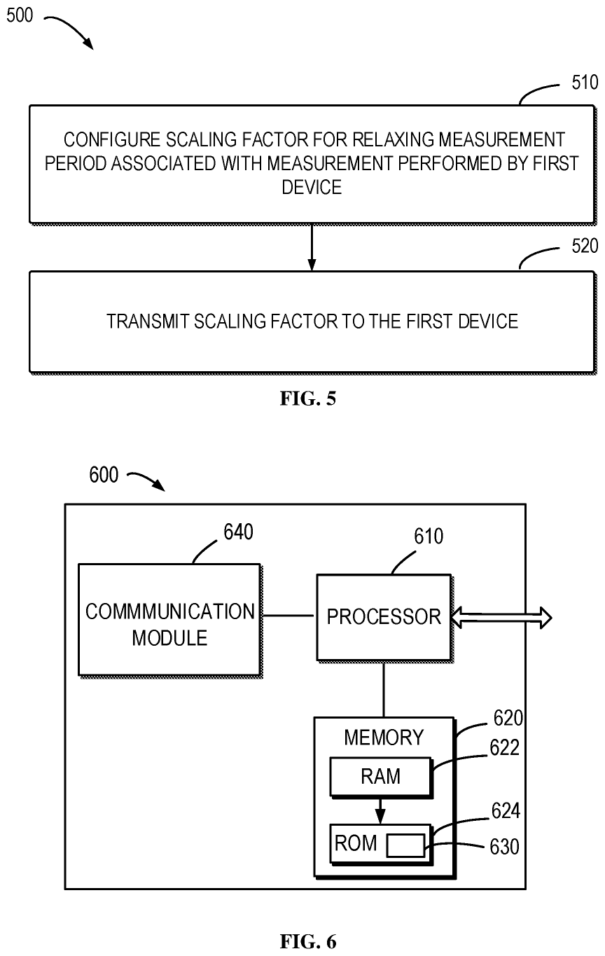

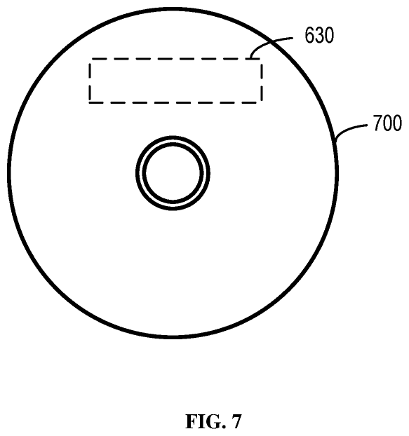

FIG. 5 shows a flowchart of an example method 500 of the measurement requirement for the energy saving according to some example embodiments of the present disclosure. The method 500 may be implemented at the second device 120 shown in FIG. 1. For the purpose of discussion, the method 500 will be described with reference to FIG. 1.

At 510, the second device 120 configures a scaling factor for relaxing a measurement period associated with a measurement performed by a first device.

At 520, the second device 120 transmits the scaling factor to the first device.

In some example embodiments, the second device may transmit, to the first device, an indication that a discontinuous transmission, DTX, is enabled by the second device.

In some example embodiments, the second device may receive, from the first device, an indication that the measurement period is relaxed for the measurement.

In some example embodiments, the first device comprises a terminal device and the second device comprises a network device.

In some example embodiments, an apparatus capable of performing the method 400 (for example, implemented at the first device 110) may include means for performing the respective steps of the method 400. The means may be implemented in any suitable form. For example, the means may be implemented in a circuitry or software module.

In some example embodiments, the apparatus comprises means for, in accordance with a determination that a DTX is enabled by a second device, determining a relaxed measurement period associated with a measurement performed by the first device; and means for performing the measurement based on the relaxed measurement period or an unrelaxed measurement period.

In some example embodiments, the apparatus may further comprise means for determining that the DTX is enabled by the second device based on the network indication.

In some example embodiments, the means for determining the relaxed measurement period comprises means for determining the relaxed measurement period based on a scaling factor, which is determined by the first device considering an overlapping ratio between the DTX period and at least one of a measurement gap for the measurement, one or more SSB or CSI-RS symbols to be measured, or a SMTC period or a CSI-RS periodicity.

In some example embodiments, the apparatus may further comprise means for determining whether the measurement gap is configured; and means for, in accordance with determination that the measurement gap is configured, determining the scaling factor based on a ratio of the SMTC period to a minimum value between the DTX period and the measurement gap periodicity.

In some example embodiments, the apparatus may further comprise means for, in accordance with determination that the measurement gap is not configured, determining the scaling factor based on a ratio of the SMTC period to the DTX period.

In some example embodiments, the apparatus may further comprise means for, in accordance with a determination that the DTX is not configured with a fix period, determine the overlapping ratio by monitoring the one or more symbols of SSB or CSI-RS within a predetermined period being muted after the DTX is enabled or the SMTC windows within the predetermined period being muted after the DTX is enabled.

In some example embodiments, the means for determining the relaxed measurement period comprises means for determining the relaxed measurement period based on a scaling factor configured by the second device.

In some example embodiments, the means for performing the measurement may comprises means for in accordance with a determination that at least one channel quality criterion is not fulfilled, determining that the relaxed measurement period is to be used for the measurement; or means for in accordance with a determination that the at least one channel quality criterion is fulfilled, determining that the unrelaxed measurement period is to be used for the measurement.

In some example embodiments, the at least one channel quality criterion comprises at least one of a channel quality is above a threshold level or a channel quality variation is within a threshold range within a predetermined time period.

In some example embodiments, the apparatus may further comprise means for transmitting, to the second device, an indication that the relaxed measurement period is used for the measurement.

In some example embodiments, the first device comprises a terminal device and the second device comprises a network device.

In some example embodiments, an apparatus capable of performing the method 500 (for example, implemented at the second device 120) may include means for performing the respective steps of the method 500. The means may be implemented in any suitable form. For example, the means may be implemented in a circuitry or software module.

In some example embodiments, the apparatus comprises means for configuring a scaling factor for relaxing a measurement period associated with a measurement performed by a first device; and means for transmitting the scaling factor to the first device.

In some example embodiments, the apparatus may further comprise means for receiving, from the first device, an indication that the measurement period is relaxed for the measurement.

In some example embodiments, the apparatus may further comprise means for transmitting, to the first device, an indication that a discontinuous transmission, DTX, is enabled by the second device.

In some example embodiments, the first device comprises a terminal device and the second device comprises a network device.

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A first device comprising:
at least one processor; and
at least one memory storing instructions that, when executed by the at least one processor, cause the first device at least to:
in accordance with a determination that a discontinuous transmission (DTX) is enabled by a second device, determine a relaxed measurement period associated with a measurement performed by the first device, wherein the first device is caused to determine the relaxed measurement period based on a scaling factor, wherein the scaling factor is determined by the first device considering an overlapping ratio between a DTX period and the following:
a measurement gap for the measurement,
one or more symbols used for the measurement of at least one of the following:
a Synchronization Signaling Block (SSB);
Channel State Information-Reference Signal (CSI-RS);
a SSB measurement timing configuration (SMTC) period or a CSI-RS periodicity;
determine that the DTX is enabled based on an indication received from the second device;
determine whether the measurement gap is configured;
in accordance with determination that the measurement gap is configured, determine the scaling factor based on a ratio of the SMTC period to a minimum value between the DTX period and a measurement gap periodicity; and
in accordance with determination that the measurement gap is not configured, determine the scaling factor based on a ratio of the SMTC period to the DTX period; and
perform the measurement based on the relaxed measurement period or an unrelaxed measurement period.

36. The first device of claim 35, wherein the first device is caused to:
in accordance with a determination that the DTX is not configured with a fix period, determine the overlapping ratio by monitoring one of:
the one or more symbols of SSB or CSI-RS within a predetermined period being muted after the DTX is enabled, or
SMTC windows within the predetermined period being muted after the DTX is enabled.

37. The first device of claim 36, wherein the first device is caused to determine the relaxed measurement period based on a scaling factor configured by the second device.

38. The first device of claim 37, wherein the first device is caused to:
in accordance with a determination that at least one channel quality criterion is not fulfilled, determine that the relaxed measurement period is to be used for the measurement; or
in accordance with a determination that the at least one channel quality criterion is fulfilled, determine that the unrelaxed measurement period is to be used for the measurement.

39. The first device of claim 38, wherein the at least one channel quality criterion comprises the following:
a channel quality is above a threshold level; and
a channel quality variation is within a threshold range within a predetermined time period.

40. The first device of claim 39, wherein the first device is caused to:
transmit, to the second device, an indication that the relaxed measurement period is used for the measurement.

41. The first device of claim 40, wherein the first device comprises a terminal device and the second device comprises a network device.

42. A system comprising:
a first device;
at least one processor; and
at least one memory storing instructions that, when executed by the at least one processor, cause the first device at least to:
in accordance with a determination that a discontinuous transmission (DTX) is enabled by a second device, determine a relaxed measurement period associated with a measurement performed by the first device, wherein the first device is caused to determine the relaxed measurement period based on a scaling factor, wherein the scaling factor is determined by the first device considering an overlapping ratio between a DTX period and the following:
a measurement gap for the measurement,
one or more symbols used for the measurement of at least one of the following:
a Synchronization Signaling Block (SSB);
Channel State Information-Reference Signal (CSI-RS);
a SSB measurement timing configuration (SMTC) period or a CSI-RS periodicity;
determine that the DTX is enabled based on an indication received from the second device;
determine whether the measurement gap is configured;
in accordance with determination that the measurement gap is configured, determine the scaling factor based on a ratio of the SMTC period to a minimum value between the DTX period and a measurement gap periodicity; and
in accordance with determination that the measurement gap is not configured, determine the scaling factor based on a ratio of the SMTC period to the DTX period; and
perform the measurement based on the relaxed measurement period or an unrelaxed measurement period.

43. The system of claim 42, wherein the first device is caused to:
in accordance with a determination that the DTX is not configured with a fix period, determine the overlapping ratio by monitoring one of:
the one or more symbols of SSB or CSI-RS within a predetermined period being muted after the DTX is enabled, or
SMTC windows within the predetermined period being muted after the DTX is enabled.

44. The system of claim 43, wherein the first device is caused to determine the relaxed measurement period based on a scaling factor configured by the second device.

45. The system of claim 44, wherein the first device is caused to:
in accordance with a determination that at least one channel quality criterion is not fulfilled, determine that the relaxed measurement period is to be used for the measurement; or
in accordance with a determination that the at least one channel quality criterion is fulfilled, determine that the unrelaxed measurement period is to be used for the measurement.

46. The system of claim 45, wherein the at least one channel quality criterion comprises the following:
a channel quality is above a threshold level; and
a channel quality variation is within a threshold range within a predetermined time period.

47. The system of claim 46, wherein the first device is caused to:
transmit, to the second device, an indication that the relaxed measurement period is used for the measurement.

48. The system of claim 47, wherein the first device comprises a terminal device and the second device comprises a network device.

49. A method comprising:
in accordance with a determination that a discontinuous transmission (DTX) is enabled by a second device, determining, by a first device, a relaxed measurement period associated with a measurement performed by the first device, wherein the first device is caused to determine the relaxed measurement period based on a scaling factor, wherein the scaling factor is determined by the first device considering an overlapping ratio between a DTX period and the following:
a measurement gap for the measurement,
one or more symbols used for the measurement of at least one of the following:
a Synchronization Signaling Block (SSB);
Channel State Information-Reference Signal (CSI-RS);
a SSB measurement timing configuration (SMTC) period or a CSI-RS periodicity;
determining that the DTX is enabled based on an indication received from the second device;
determining whether the measurement gap is configured;
in accordance with determination that the measurement gap is configured, determining the scaling factor based on a ratio of the SMTC period to a minimum value between the DTX period and a measurement gap periodicity; and
in accordance with determination that the measurement gap is not configured, determining the scaling factor based on a ratio of the SMTC period to the DTX period; and
performing the measurement based on the relaxed measurement period or an unrelaxed measurement period.

50. The method of claim 49, further comprising:
in accordance with a determination that the DTX is not configured with a fix period, determine the overlapping ratio by monitoring one of:
the one or more symbols of SSB or CSI-RS within a predetermined period being muted after the DTX is enabled, or
SMTC windows within the predetermined period being muted after the DTX is enabled.

51. The method of claim 50, further comprising determining, by the first device the relaxed measurement period based on a scaling factor configured by the second device.

52. The method of claim 51, further comprising:
in accordance with a determination that at least one channel quality criterion is not fulfilled, determine that the relaxed measurement period is to be used for the measurement; or
in accordance with a determination that the at least one channel quality criterion is fulfilled, determine that the unrelaxed measurement period is to be used for the measurement.

53. The method of claim 52, wherein the at least one channel quality criterion comprises the following:
a channel quality is above a threshold level; and
a channel quality variation is within a threshold range within a predetermined time period.

54. The method of claim 53, further comprising:
transmitting, to the second device, an indication that the relaxed measurement period is used for the measurement.
